(19) United States
(12) Patent Application Publication
(10) Pub. No.: US 2009/0165820 A1
(43) Pub. Date: Jul. 2, 2009

(54) METHOD OF DISPOSING OF SOILED LIQUID FROM A SUMP ASSEMBLY FOR A RE-CIRCULATING WAREWASHING MACHINE

(75) Inventors: Ben Jeremiah Wiltsie, Minneapolis, MN (US); Eddie D. Sowle, Woodbury, MN (US)

Correspondence Address: ECOLAB INC., MAIL STOP ESC-F7, 655 LONE OAK DRIVE, EAGAN, MN, 55121, US

(73) Assignee: ECOLAB INC., St. Paul, MN (US)

(21) Appl. No.: 12/398,293

(22) Filed: Mar. 5, 2009

Related U.S. Application Data
(62) Division of application No. 11/332,021, filed on Jan. 13, 2006.

(51) Int. Cl. B08B 7/04

(52) U.S. Cl. 134/10

(57) ABSTRACT

A sump assembly includes a sump, a divider, and a drain. The sump has a top, a bottom, and a cavity in which rinse water and soiled water are stored. The divider divides the cavity into a first portion and a second portion, which are in fluid communication. The drain is in fluid communication with the second portion. A first water level is approximately level with the drain's opening. During the rinse cycle, the rinse water enters the first portion proximate the top of the sump and raises the first water level to a second water level in the first portion. The rinse water is proximate the top and the soiled water is proximate the bottom of the sump. The second water level directs soiled water proximate the bottom of the sump from the first portion into the second portion where the soiled water is directed into the drain.

### RELATED APPLICATIONS

This application is a divisional of U.S. patent application Ser. No. 11/332,021, filed Jan. 13, 2006, entitled, “Sump Assembly For A Re-Circulating Warewashing Machine,” the entire disclosure of which is incorporated herein by reference in its entirety for all purposes.

### FIELD OF THE INVENTION

The present invention relates to warewashing using a re-circulating warewashing machine.

### BACKGROUND OF THE INVENTION

In a re-circulating warewashing machine, wash water and rinse water are directed into and stored in a sump of the re-circulating warewashing machine and then pumped into the wash arms in subsequent wash cycles. For the initial wash cycle, detergent is added to water to create wash water for use during the initial wash cycle, and the wash water is directed into and stored in the sump of the warewashing machine for use in subsequent wash cycles. Fresh water, which may include an optional rinse aid, is as rinse water during each of the rinse cycles, and the rinse water is also directed into and stored in the sump of the warewashing machine. During subsequent wash and rinse cycles, the wash water and the rinse water are directed into and stored in the sump of the dishwashing machine for use as wash water in the subsequent wash cycles. The rinse water displaces a proportional amount of water in the sump, which flows into a drain, thereby diluting the sump water. Because the wash water is diluted with the rinse water, detergent should be added to the water stored in the sump for use in subsequent wash cycles. However, less detergent than is needed initially is needed for use in subsequent wash cycles since the sump water includes detergent from previous wash cycles. Because the sump water is used in several wash cycles, the sump water can become very soiled over time.

High soil levels in the sump water can lead to re-deposition of soils on wares and decreases the detersive action of the chemicals added to the wash water. Therefore, it is desired to direct the soiled water out of sump so that it can be replaced with relatively cleaner water resulting in lower soil levels in wash water for subsequent cycles.

### SUMMARY OF THE INVENTION

In one aspect of the invention, a sump assembly of a re-circulating warewashing machine having a rinse cycle and a wash cycle includes a sump, a divider, a drain, a first water level, and a second water level. The sump has a top, a bottom, and a cavity in which water used in the re-circulating warewashing machine is stored. The water includes rinse water from the rinse cycle and soiled water from the wash cycle. During the rinse cycle, the rinse water is proximate the top of the sump and the soiled water is proximate the bottom of the sump. The divider defines a first portion and a second portion of the cavity. The first portion is in fluid communication with the second portion, and the drain has an opening and is in fluid communication with the second portion. The first water level is approximately level with the opening of the drain. As the rinse water enters the first portion of the cavity, the second water level is approximately above the opening of the drain in the first portion. The second water level directs soiled water proximate the bottom of the sump from the first portion into the second portion where the soiled water is directed into the drain thereby replacing soiled water with rinse water in the sump during the rinse cycle.

In another aspect of the invention, a sump assembly of a re-circulating warewashing machine having a rinse cycle and a wash cycle includes a sump, a divider, a drain, a first water level, and a second water level. The sump has a top, sides, a bottom, and a cavity in which water used in the re-circulating warewashing machine is stored. The water includes rinse water from the rinse cycle and soiled water from the wash cycle. During the rinse cycle, the rinse water is proximate the top of the sump and the soiled water is proximate the bottom of the sump. The divider has a partition extending from opposing sides of the sump proximate the top of the sump toward proximate a middle of the sump. The partition defines a gap between the divider and the bottom of the sump and defines a first portion and a second portion of the cavity. The first portion and the second portion are in fluid communication via the gap interconnecting the first portion and the second portion. The drain has an opening and is in fluid communication with the second portion. The first water level is approximately level with the opening of the drain. As the rinse water enters the first portion of the cavity, the second water level is above the opening of the drain in the first portion. The rinse water raises the first water level to the second water level in the first portion, and the drain maintains approximately the first water level in the second portion. The rinse water exerts a pressure on the soiled water in the first portion thereby directing the soiled water in the first portion through the gap and into the second portion where the soiled water is directed into the drain until approximately the first water level returns in the first portion thereby replacing soiled water with rinse water in the sump during the rinse cycle.

In another aspect of the invention, a sump assembly of a re-circulating warewashing machine having a rinse cycle and a wash cycle includes a sump, a drain, a divider, a first water level, and a second water level. The sump has a top, a bottom, and a cavity in which water used in the re-circulating warewashing machine is stored. The water includes rinse water from the rinse cycle and soiled water from the wash cycle. During the rinse cycle, the rinse water is proximate the top of the sump and the soiled water is proximate the bottom of the sump. The drain has an opening. The divider defines a first portion and a second portion of the cavity and has a top with an aperture proximate the opening of the drain. The first portion is in fluid communication with the second portion, and the second portion is in fluid communication with the opening of the drain. The first water level is approximately level with the opening of the drain. As the rinse water enters the first portion of the cavity, the second water level is above the opening of the drain in the first portion. The second water level covers the aperture of the divider and fills the second portion proximate the opening of the drain to create a siphon directing soiled water proximate the bottom of the sump from the first portion into the second portion where the soiled water is directed into the drain thereby replacing soiled water with rinse water in the sump until the aperture is no longer covered with water in the first portion proximate the first water level.

In another aspect of the invention, a method of disposing of soiled water from a sump of a re-circulating warewashing machine having a rinse cycle and a wash cycle includes dividing the sump into a first portion and a second portion. The first portion and the second portion are in fluid communication, and the second portion is in fluid communication with a drain. Soiled water is directed from the wash cycle into the sump, and the soiled water is stored in the sump at a first water level. Rinse water from the rinse cycle is directed into the first portion of the sump proximate the top of the sump increasing the first water level to a second water level in the first portion. The drain maintains the first water level in the second portion. The second water level directs the soiled water proximate the bottom of the sump from the first portion into the second portion where it is directed into the drain until approximately the first water level returns in the first portion.

### BRIEF DESCRIPTION OF THE DRAWINGS

FIG. 1 is a side perspective view of an insert constructed according to the principles of the present invention;

FIG. 2 is a back perspective view of the insert shown in FIG. 1;

FIG. 3 is a front perspective view of the insert shown in FIG. 1;

FIG. 4 is a top view of the insert shown in FIG. 1 in a sump of a warewashing machine;

FIG. 5 is a top view of the insert shown in FIG. 1 with the top removed in a sump of a warewashing machine;

FIG. 6A is a schematic showing the water level in the sump at the beginning of the rinse cycle using the insert shown in FIG. 1;

FIG. 6B is a schematic showing the water level in the sump during the rinse cycle using the insert shown in FIG. 1;

FIG. 7 is a perspective view of another embodiment insert constructed according to the principles of the present invention;

FIG. 8 is a perspective view of the insert shown in FIG. 7 operatively connected to a drain;

FIG. 9 is a top perspective view of the insert shown in FIG. 7 operatively connected to a drain in a sump of a warewashing machine;

FIG. 10A is a schematic showing the water level in the sump at the beginning of the rinse cycle using the insert shown in FIG. 7;

FIG. 10B is a schematic showing the water level in the sump during the rinse cycle using the insert shown in FIG. 7;

FIG. 11 is a perspective view of another embodiment insert constructed according to the principles of the present invention;

FIG. 12 is a perspective view of a top portion of a drain;

FIG. 13 is a top perspective view of a drain operatively connected to a sump of a warewashing machine;

FIG. 14A is a schematic showing the water level in the sump at the beginning of the rinse cycle using the insert shown in FIG. 11;

FIG. 14B is a schematic showing the water level in the sump during the rinse cycle using the insert shown in FIG. 11;

FIG. 15 is a schematic view of a re-circulating warewashing machine; and

FIG. 16 is a graph showing soluble soil levels after several cycles of a re-circulating warewashing machine without an insert and with an insert.

### DETAILED DESCRIPTION OF PREFERRED EMBODIMENTS

Preferred embodiment inserts constructed according to the principles of the present invention are designated by the numerals 100, 200, and 300 in the drawings.

The term “water” is used herein to refer to the wash water and the rinse water, including any additives such as detergents, sanitizers, and/or rinse aids, used in a re-circulating warewashing machine and then directed into and stored in the sump of the re-circulating warewashing machine for use as wash water in subsequent wash cycles. The water may also include soils removed from the wares during the wash and rinse cycles.

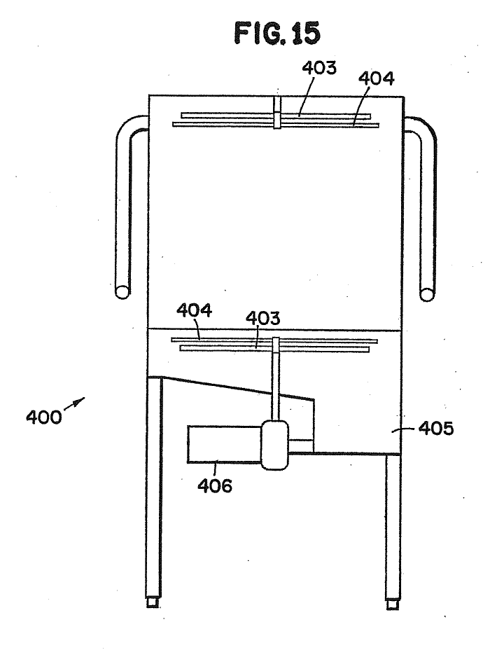

An example of a suitable re-circulating warewashing machine 400 having a sump 405 is shown in FIG. 15, which may be a Hobart AM-14. Wash water is dispensed through the wash arms 403 and rinse water is dispensed through the rinse arms 404. The wash water and the rinse water are directed into and stored in the sump 405. Detergent is typically added to the sump water which is then pumped via pump 406 into the wash arms 403 for use as wash water in subsequent wash cycles.

Generally, during the rinse cycle and before the wash cycle, the rinse water is proximate the top of the sump and the soiled water is proximate the bottom of the sump. This can be attributed to several factors including the rinse water enters the sump from the top of the sump, the rinse water has a higher temperature than the soiled water, and the rinse water includes less soil than the soiled water. During the wash cycle, the rinse water and the soiled water is mixed together into soiled water. To keep the water in the sump as clean as possible for longer periods of time, it is desired to remove the more soiled water proximate the bottom of the sump from the sump so that less soiled water is mixed with the rinse water for use as wash water in subsequent wash cycles. This can be accomplished using the present invention.

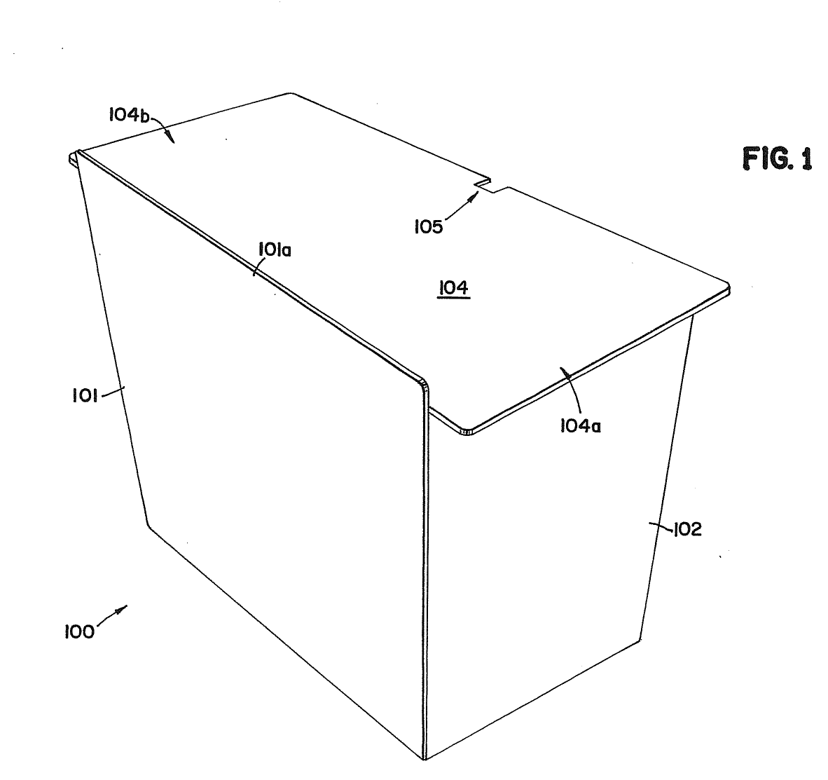

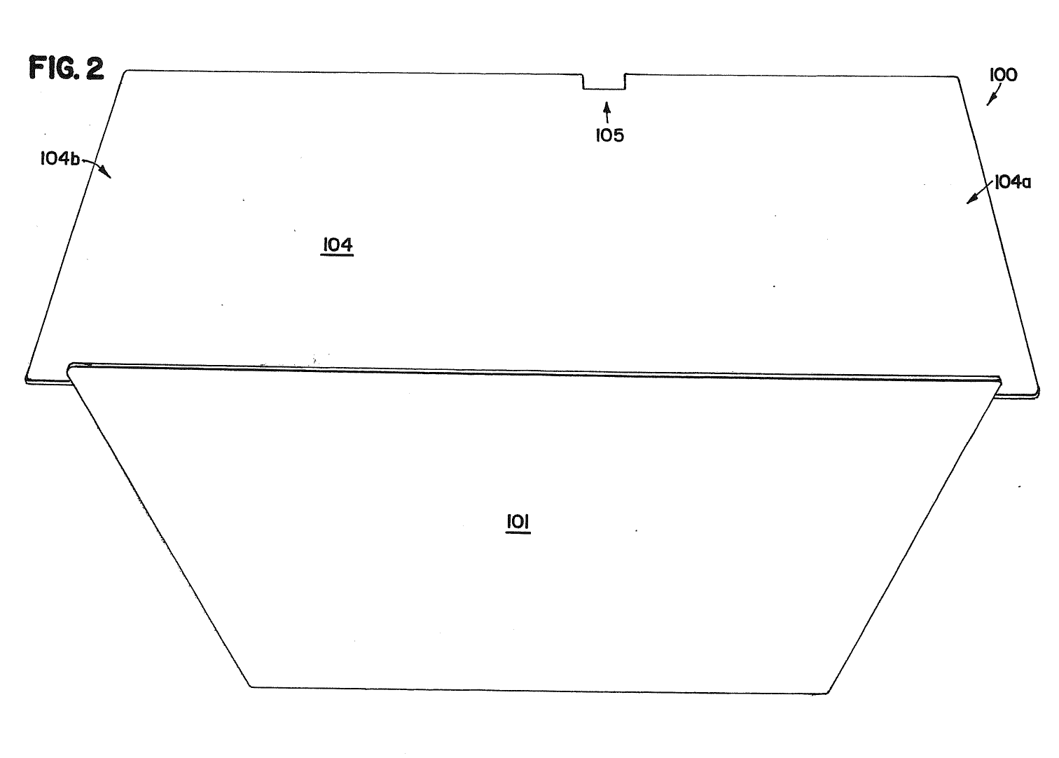

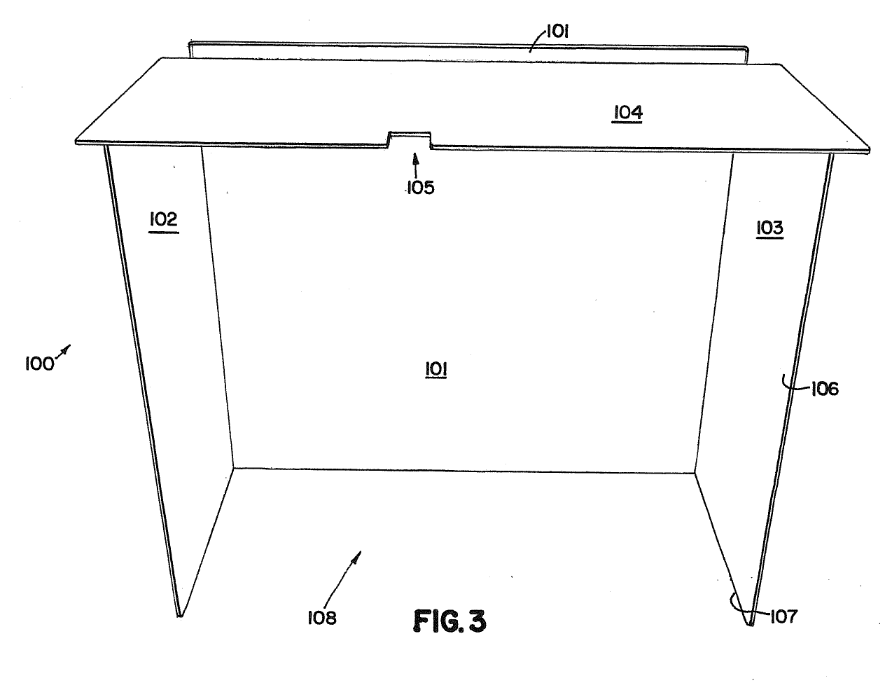

In one aspect of the present invention, the insert 100 is a four-sided rectangular insert having a back 101, a first side 102, a second side 103, and a top 104 configured and arranged to fit within a cavity 117 of a sump 115 of a re-circulating warewashing machine. The sides 102 and 103 are parallel to one another and the back 101 interconnects the edges on one side of the sides 102 and 103 creating a space between the sides 102 and 103 approximately the length of the back 101. The top 104 interconnects the back 101 and the top edges of the sides 102 and 103. The back 101 extends upward beyond the top 104 forming a flange 101a, and the top 104 extends outward beyond the sides 102 and 103 forming flanges 104a and 104b, respectively. The top 104 includes an optional notch 105 on the side opposite the back 101. The insert 100 does not include a front or a bottom so there is a front opening 106 and a bottom opening 107 allowing access to a cavity 108 defined by the insert 100. The insert 100 is shown in FIGS. 1-3.

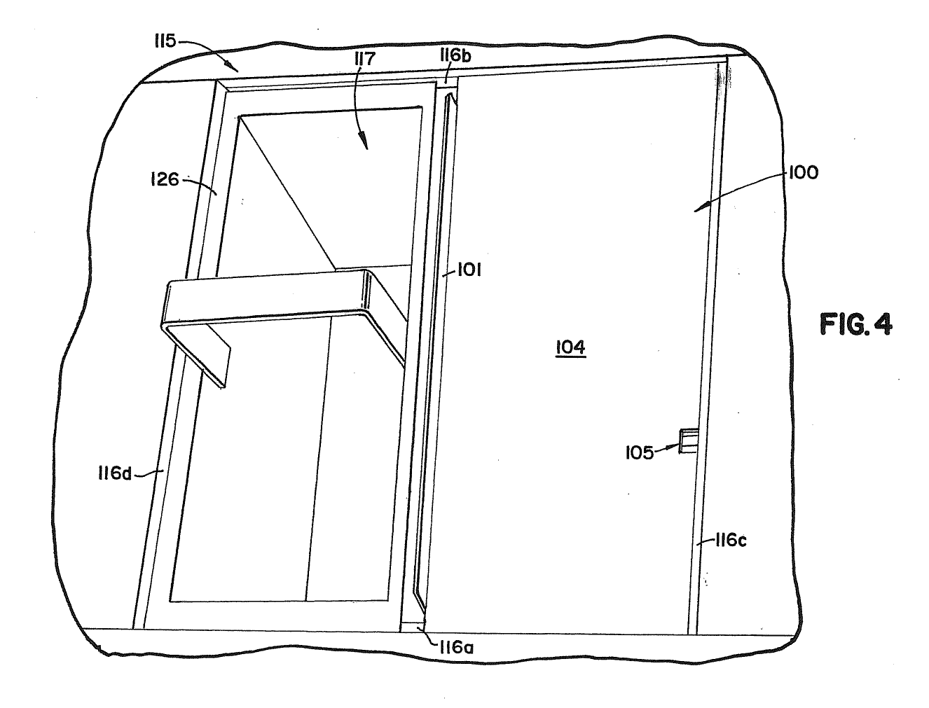

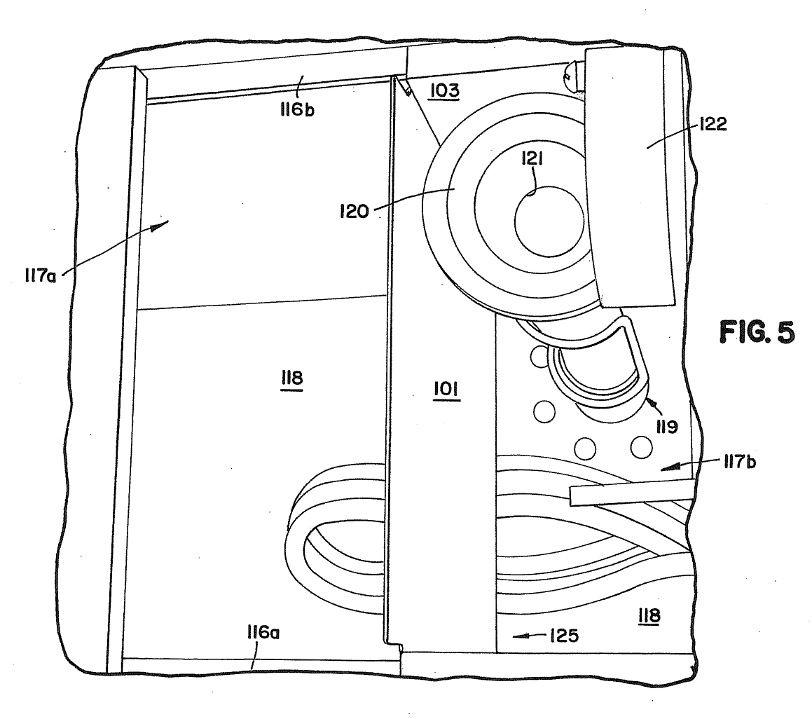

The insert 100 is shown in a typical sump in FIGS. 4-5. The sump 115 includes a first side 116a, a second side 116b, a third side 116c, a fourth side 116d, and a bottom 118 defining the cavity 117. Proximate the second side 116b and the third side 116c is a drain hole 119 in the bottom 118 of the sump 115. A drain 120 having a bore 121 extends upward from the bottom 118 and is in fluid communication with the drain hole 119. A drain lever 122 is operatively connected to the drain 120, and the drain 120 is lifted upward with the drain lever 122 to unplug the drain hole 119. The notch 105 accommodates the drain lever 122 so that the drain 120 can be lifted without having to remove the insert 100. When the water in the cavity 117 reaches the top of the drain 120, the water flows through the bore 121 and into the drain for disposal. When it is desired to drain the cavity 117 of substantially all of the water, the drain lever 122 is pulled upward which pulls upward on the drain 120 to unplug the drain hole 119 allowing the water to exit through the drain hole 119 directly. When the drain 120 plugs the drain hole 119, water must exit the cavity through the bore 121.

The insert 100 fits within the cavity 117 and divides the cavity 117 into a first portion 117a and a second portion 117b. To insert the insert 100 in the sump 115, front opening 106 is placed proximate the third side 116c of the sump and the back 101 is placed proximate the middle of the cavity 117. The flange 104a rests on top of the first side 116a and the flange 104b rests on top of the second side 116b. The back 101 is proximate the middle of the sump 117 and extends from the first side 116a to the second side 116b proximate the top but does not extend all the way to the bottom 118 of the sump 115. Thus, there is a gap 125 proximate the bottom 118 of the sump 117. The back 101 acts as a partition between the first portion 117a and the second portion 117b with the gap 125 interconnecting the first portion 117a and the second portion 117b proximate the bottom 118 of the cavity 117 since the back 101 does not extend all the way to the bottom 118. An optional strainer 126 may be placed proximate the first portion 117a to prevent large soils from entering the remainder of the sump 117.

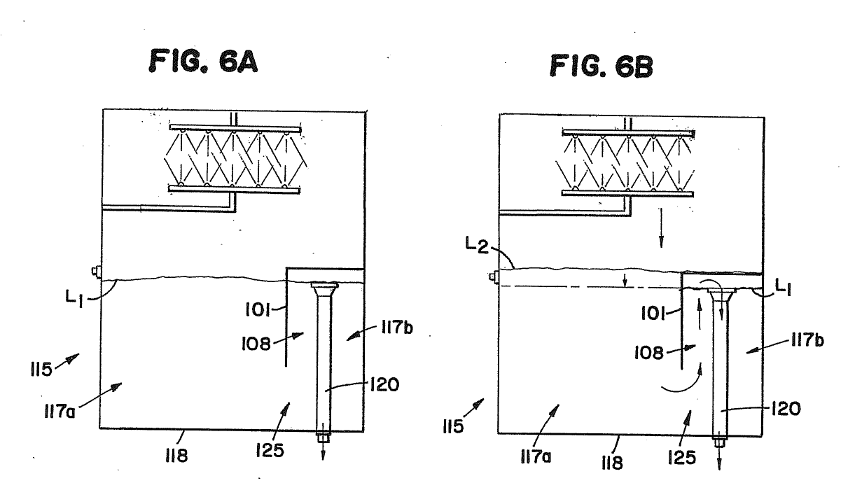

In operation, as shown in FIGS. 6A and 6B, at the beginning of the rinse cycle, there is a first water level L₁ in the sump 115. The first water level L₁ is approximately level with the top of the drain 120 proximate the bore 121. Because the bore 121 is an opening that is always open, any excess sump water rising above the level of the bore 121 will flow into the bore 121. During the rinse cycle, as relatively clean, hot, rinse water is dispensed from the rinse arms, the rinse water is directed into the first portion 117a of the sump 115, which raises the water level in the first portion 117a from the first water level L₁ to a second water level L₂, which is above the height of the drain 120. The rinse water is proximate the top of the sump 115 and the relatively soiled water is proximate the bottom of the sump 115 in the first portion 117a. The first water level L₁ remains in the second portion 117b because any water rising above the drain 120 flows into the bore 121. The back 101 of the insert 100 allows the water level to rise in the first portion 117a because it is partitioned from the second portion 117b in which the drain 120 is positioned. Because of gravity, the rinse water exerts a pressure on the relatively soiled water in the first portion 117a, which pushes the relatively soiled water from proximate the bottom 118 of the sump 115 of the first portion 117a, through the gap 125, into the second portion 117b within the cavity 108, upward within the cavity 108, and into the drain 120 thereby removing more of the soiled water from the sump 115 and allowing the removed soiled water to be replaced by the rinse water resulting in relatively cleaner sump water.

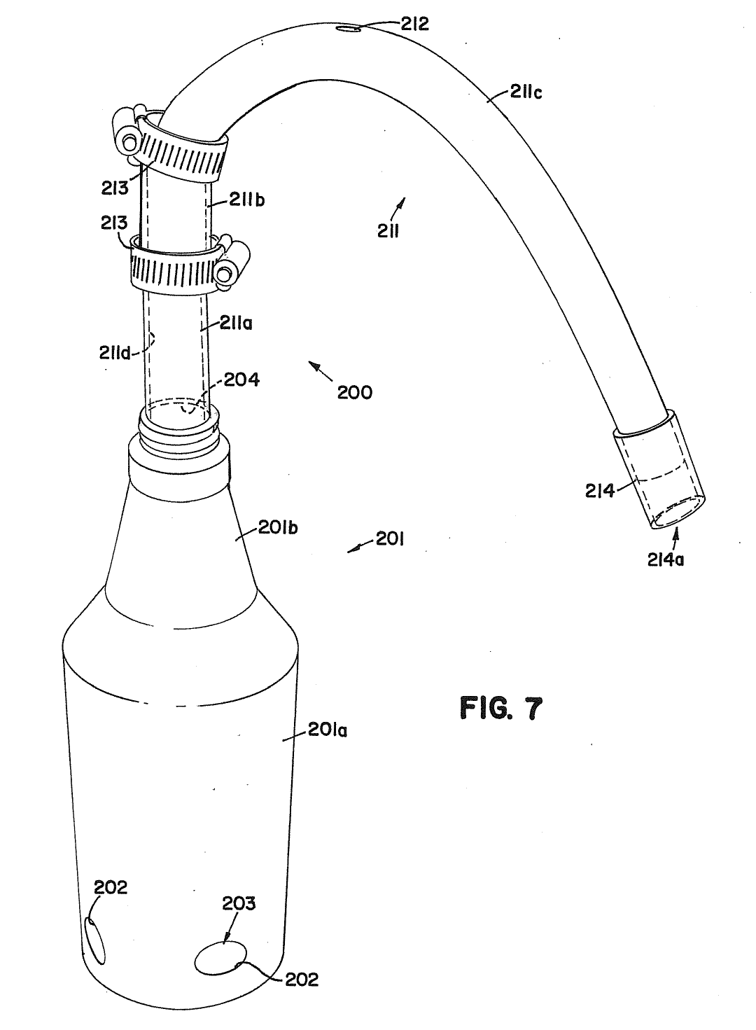

In another aspect of the present invention, as shown in FIG. 7, the insert 200 preferably includes an inlet portion 201 and an outlet portion 211. The inlet portion 201 has a cylindrical bottom 201a and a frustoconical top 201b, which are preferably of unitary construction and are bottle-shaped. The bottom 201 a includes an opening such as a plurality of apertures 202 proximate the bottom of the bottom 201a. The plurality of apertures 202 are preferably four apertures approximately ninety degrees from the adjacent apertures allowing access to a cavity 203 within the insert 200. The top 201b includes an aperture 204 proximate the top of the top 201b also allowing access to the cavity 203. The apertures 202 are in fluid communication with the aperture 204.

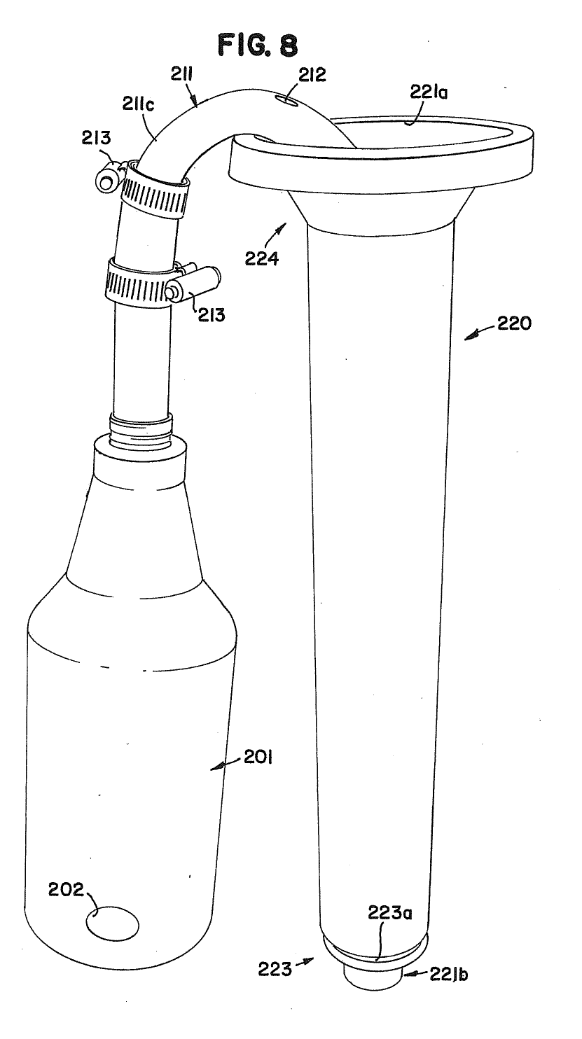

The outlet portion 211 is preferably a flexible conduit having a longitudinally extending bore 211 d and may include one or more portions. A first portion 211a is operatively connected to the top 201b and is in fluid communication with the cavity 203 via the aperture 204 of the top 201b and the bore 211d of the outlet portion 211. A second portion 211b interconnects the first portion 211a and a third portion 211c with the bore 211d extending through each of the portions. The portions 211a, 211b, and 211c may be connected using clamps 213. The outlet portion 211 is preferably flexible so that it curves upward from the inlet portion 201 and then downward into the drain 220 in an upside down U-shape, as shown in FIG. 8. Proximate the top of the outlet portion 211, which is the highest height of the outlet portion 211, the third portion 211c includes an aperture 212. The third portion 211c also includes an outlet 214 with an opening 214a, which is in fluid communication with the bore 211d.

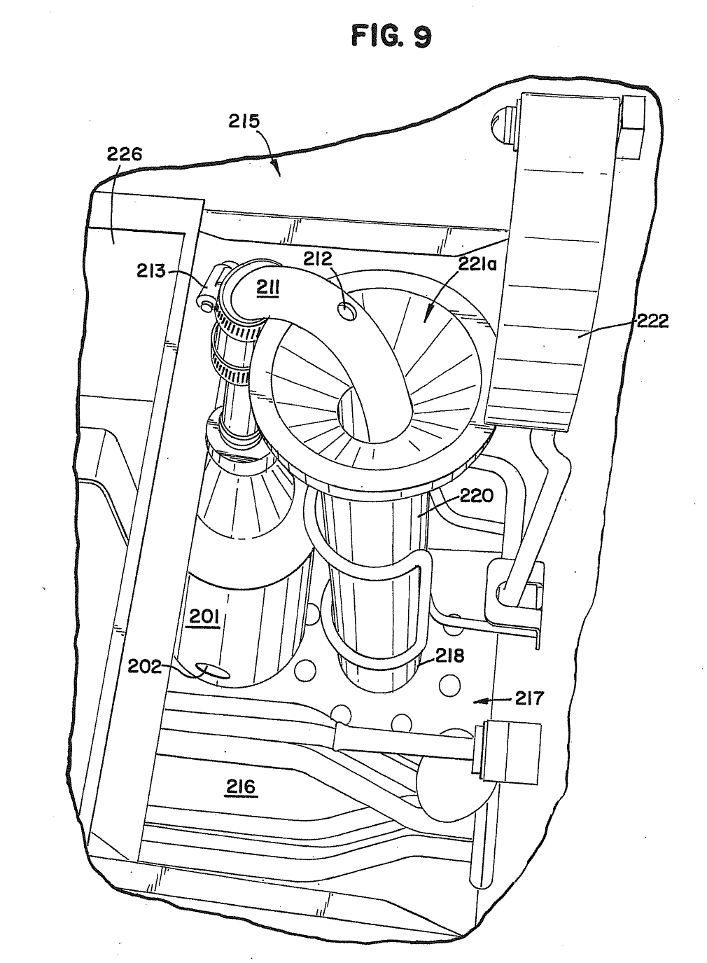

The drain 220 includes a drain bore inlet 221a, which is an opening into the drain 220, proximate the top 224 in fluid communication with a drain bore outlet 221b proximate the bottom 223 of the drain 220. As shown in FIG. 9, a sump 215 includes a cavity 217 and an aperture 218 in a bottom 216 of the sump 215. The bottom 223 of the drain 220 is configured and arranged to be inserted into the aperture 218, and an O-ring 223a seals the connection of the drain 220 and the bottom 216 of the sump 215. The sump water may either exit the aperture 218 of the sump 215 by flowing into the drain bore inlet 221a and out of the drain bore outlet 221b thus leaving a first water level L₃ of sump water in the sump 215 proximate the top 224 of the drain 220 or by lifting the drain 220 up with a drain lever 222 to unplug the aperture 218 thus allowing substantially all of the water to drain out of the sump 215. When the outlet portion 211 is inserted into the drain bore inlet 221a, the aperture 212 is proximate the top of the drain 220. An optional strainer 226 may be placed in the cavity 217 to prevent large soils from entering the insert 200.

The insert 200 divides the cavity 217 into a first portion 217a, which is outside of the insert 200, and a second portion 217b, which is inside of the insert 200 within its cavity 203. Because of the apertures 202 in the inlet portion 201, the cavity 203 of the insert 200 is in fluid communication with the cavity 217 of the sump and sump water may flow between the cavities 217 and 203.

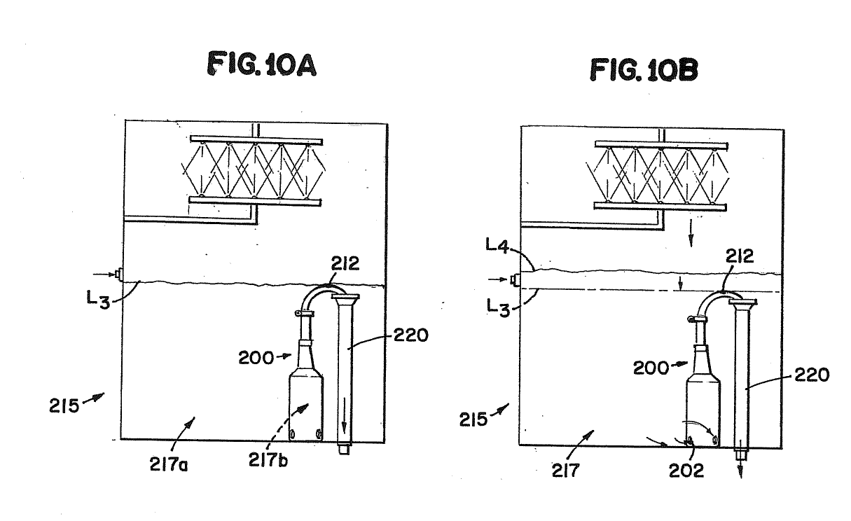

In operation, as shown in FIGS. 10A and 10B, at the beginning of the rinse cycle, there is a first water level L₃ in the sump 215. During the rinse cycle, as relatively clean, hot, rinse water is dispensed from the rinse arms, the rinse water is directed into the first portion 217a of the cavity 217, which raises the water level in the sump 215 from the first water level L₃ to a second water level L₄, which is above the height of the drain 220. The rinse water is proximate the top of the sump 215 and the relatively soiled water is proximate the bottom of the sump 215. As the water level in the sump 215 rises, the aperture 212 of the outlet portion 211 will become covered and the outlet portion 211 will fill with water through the aperture 212, which creates a siphon effect and causes the relatively soiled water proximate the bottom of the cavity 217 to be sucked into the inlet portion 201 through the apertures 202, through the outlet portion 211, and into the drain 220. When the water level has dropped and the aperture 212 is no longer covered with water, air entering the outlet portion 211 will break the siphon effect thus keeping the water level at approximately the first water level L₃.

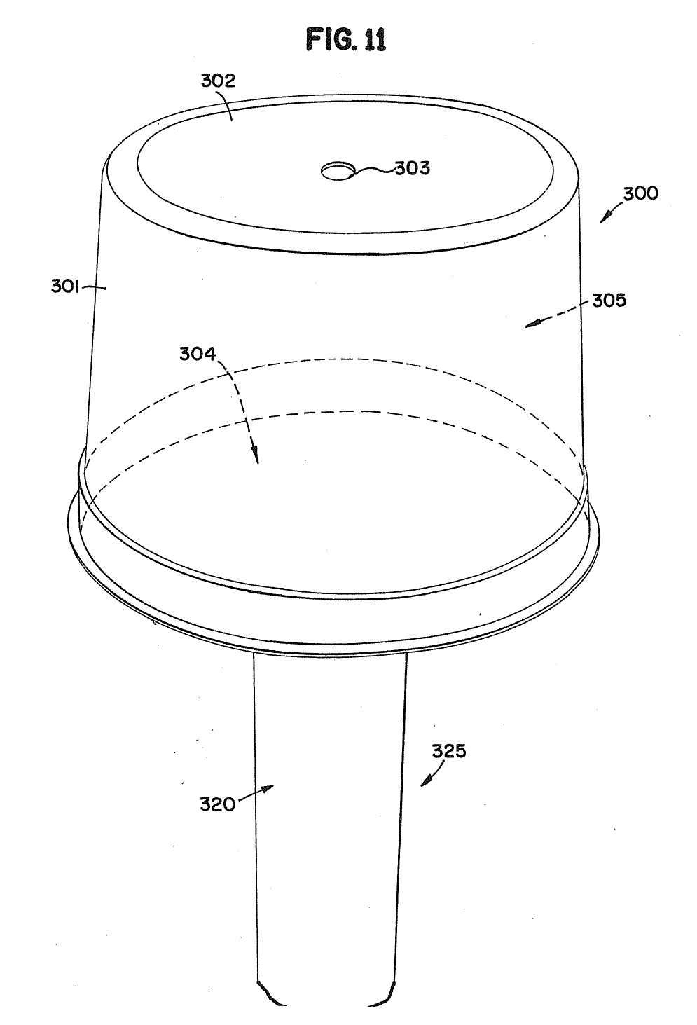

In another aspect of the present invention, as shown in FIG. 11, the insert 300 preferably includes sides 301 and a top 302 having an aperture 303. The sides 301 are preferably cylindrical with the top 302 covering the top of the sides 301 with the bottom being uncovered to provide an opening 304 into a cavity 305. The insert 300 resembles an upside down bucket and is configured and arranged to fit within a cavity 317 of a sump 315.

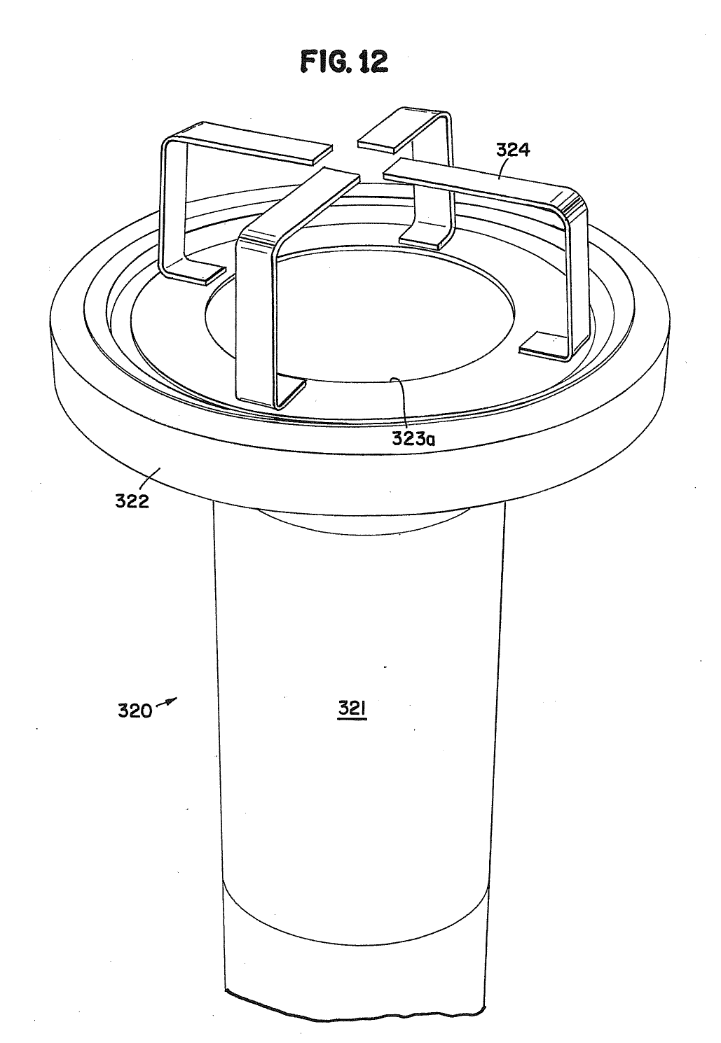

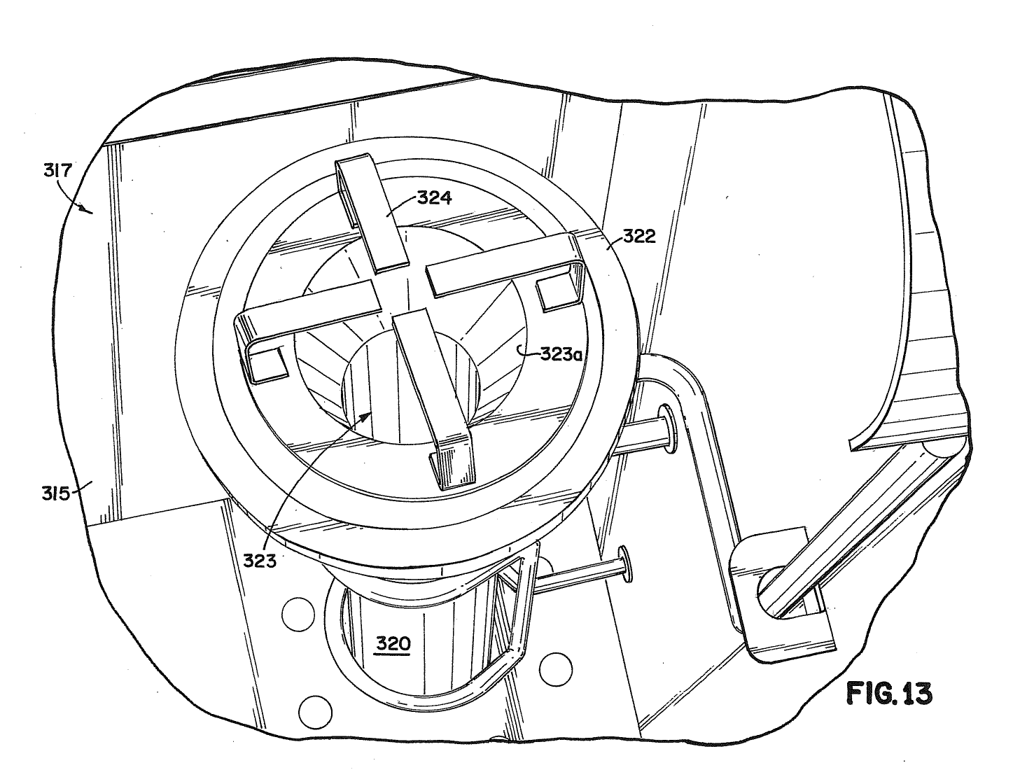

As shown in FIGS. 12 and 13, a drain 320 includes a base 321 having a flange 322 proximate the top of the base 321 and a drain bore 323 extending longitudinally through the base 321. Proximate the flange 322 is a drain bore inlet 323a. Spacers 324 are operatively connected to the flange 322 and are preferably four J-shaped brackets extending upward and inward relative to the flange 322 at approximately ninety degree angles from adjacent spacers 324.

The insert 300 is placed over the drain 320 so that the top of the drain 320 is within the cavity 305 and the top 302 contacts the spacers 324. The spacers 324 create a space between the drain 320 and the insert 300 so that the top 302 does not cover the drain bore inlet 323a. The insert 300 defines a first portion 317a and a second portion 317b in the cavity 317 of the sump 315. The first portion 317a being outside of the insert 300, and the second portion 317b being within the cavity 305 of the insert 300. The sides 301 do not extend fully to the bottom of the sump 315 creating a gap 325, which interconnects the first portion 317a and the second portion 317b.

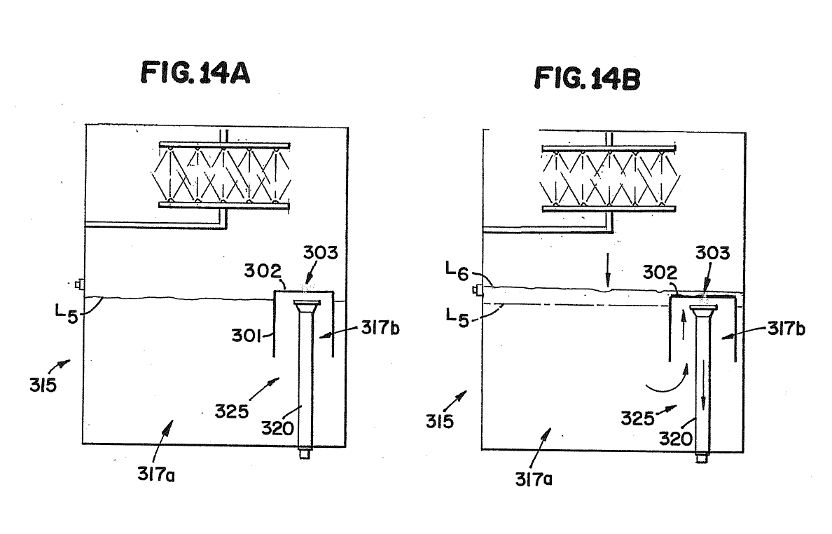

In operation, as shown in FIGS. 14A and 14B, at the beginning of the rinse cycle, there is a first water level L₅ in the sump 315. During the rinse cycle, as relatively clean, hot, rinse water is dispensed from the rinse arms, the rinse water is directed into the first portion 317a of the cavity 317, which raises the water level in the sump 315 from the first water level L₅ to a second water level L₆, which is above the height of the drain 320. The rinse water is proximate the top of the sump 315 and the relatively soiled water is proximate the bottom of the sump 315. As the water level in the sump 315 rises, the aperture 303 will become covered and the cavity 305 will fill with water, which creates a siphon effect and causes the relatively soiled water proximate the bottom of the cavity 317 to be sucked into the cavity 305 and into the drain 320. When the water level has dropped and the aperture 303 is no longer covered with water, air entering the cavity 305 will break the siphon effect thus keeping the water level at approximately the first water level L₅. Without the aperture 303 in the top 302 of the insert 300, the sump 315 will siphon until the water level is at approximately the opening 304 of the insert 300 and air enters the cavity 305. Insert 300 acts similarly to insert 200.

### EXAMPLE

A test was conducted to determine the amount of soluble soil in the water in a sump of an automatic, re-circulating warewashing machine without an insert and with an insert. The insert 100 was used.

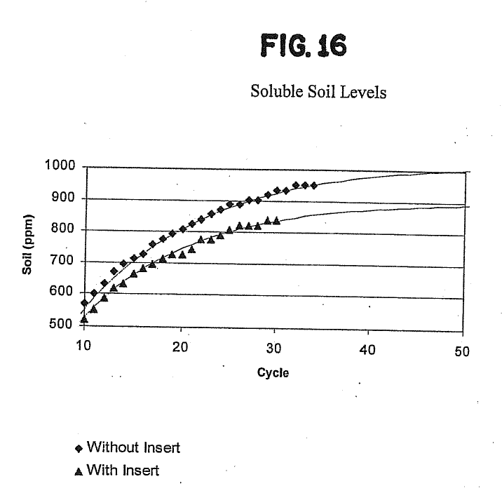

Salt was used to represent a soluble soil in the sump water. Five grams of salt was added to the sump water before each wash cycle. The soil levels were determined after each rinse cycle using a conductivity sensor. The graph in FIG. 16 shows the soluble soil levels present in the sump water from approximately the tenth cycle through the thirtieth cycle without an insert and with an insert.

As shown in the graph in FIG. 16, the soluble soils and soils with a similar density to water are present in the sump water at a lower concentration when the insert is used. This is due to the larger amount of incoming rinse water being incorporated into the sump water while more soiled water is removed from the sump.

Although the preferred embodiments are referred to and shown as inserts for retrofitting the sump of a re-circulating warewashing machine, it is recognized that the inserts may be incorporated into the sump and integral with the sump rather than being separate components inserted into the sump. For example, the insert 100 could be integral with the sump 115. It is also recognized that the inserts may be incorporated into the drain and integral with the drain rather than being separate components inserted into the sump. For example, the inserts 200 and 300 could be integral with the drains 220 and 320, respectively.

Each of the inserts 100, 200, and 300 increases the amount of rinse water incorporated into the sump water because more of the soiled water is directed out of the sump. By drawing out the soiled water proximate the bottom of the sump, the amount of food soil is reduced. The resulting reduction in food soils, which retard the detersive effects of detergent, will increase the performance of the warewashing machine. In addition, the increased incorporation of the hot rinse water decreases the energy use by the sump heater. Among the advantages, the present invention decreases the soil levels and decreases the energy use.

Any time an inlet stream of rinse water enters a sump proximate a drain, and the density is such that it does not promote mixing of the rinse water and the soiled water, a divider such as an insert or any other suitable apparatus that will provide a siphon to a controlled level can be used to decrease residence time by increasing the replacement rate. The residence time is the amount of time the soiled water is in the sump, and the replacement rate is the rate at which the soiled water is replaced with rinse water.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of disposing of soiled water from a sump of a re-circulating warewashing machine having a rinse cycle and a wash cycle, comprising:
a) dividing the sump into a first portion and a second portion, the first portion and the second portion being in fluid communication, the second portion being in fluid communication with a drain;
b) directing soiled water from the wash cycle into the sump;
c) storing the soiled water in the sump at a first water level; and
d) directing rinse water from the rinse cycle into the first portion of the sump proximate the top of the sump increasing the first water level to a second water level in the first portion, the drain maintaining the first water level in the second portion, the second water level directing the soiled water proximate the bottom of the sump from the first portion into the second portion where the soiled water is directed into the drain until approximately the first water level returns in the first portion.

2. The method of claim 1, wherein the sump is divided into the first portion and the second portion by an insert having a partition extending from opposing sides of the sump proximate a top of the sump toward proximate a middle of the sump, the partition defining a gap between the divider and a bottom of the sump, the partition defining the first portion and the second portion in fluid communication via the gap, the second water level water exerting a pressure on the soiled water in the first portion thereby directing the soiled water from the first portion, through the gap, and into the second portion where the soiled water is directed into the drain until approximately the first water level returns in the first portion.

3. The method of claim 1, wherein the sump is divided into the first portion and the second portion by an insert having an inlet portion and an outlet portion, the inlet portion including an opening proximate the bottom of the sump providing access to a cavity of the inlet portion, the cavity being in fluid communication with the outlet portion, the outlet portion including an outlet conduit in fluid communication with the drain, the outlet conduit including an aperture, the first portion being outside of the divider and the second portion being inside of the divider, wherein when the aperture is covered with rinse water in the first portion, the soiled water enters the second portion from the first portion proximate the bottom of the sump and is directed into the drain.

4. The method of claim 1, wherein the sump is divided into the first portion and the second portion by an insert having a top and sides defining a cavity and covering an inlet of the drain, the top having an aperture providing access to the cavity, the sides extending from proximate the inlet of the drain to a middle of the sump to define a gap interconnecting the first portion and the second portion, the first portion being outside of the insert and the second portion being the second cavity, wherein when the aperture is covered with rinse water in the first portion, the soiled water enters the second portion from the first portion proximate the bottom of the sump and is directed into the inlet of the drain.

5. The method of claim 1, wherein the divider and the sump are integral.

6. The method of claim 1, wherein the divider and the drain are integral.

7. A method of disposing of soiled water in a re-circulating warewashing machine having a rinse cycle and a wash cycle, comprising:
a) dividing the sump into a first portion and a second portion, the first portion and the second portion being in fluid communication, the second portion being in fluid communication with a drain;
b) providing a first water level approximately level with the opening of the drain;
c) introducing rinse water into the first portion of the sump to raise the water level to a second level above an aperture proximate the opening of the drain in the second portion, the aperture being in fluid communication with the first portion the second water level covering the aperture and filling the second portion proximate the opening of the drain creating a siphon directing soiled water proximate the bottom of the sump from the first portion into the second portion where the soiled water is directed into the drain thereby replacing soiled water with rinse water in the sump until the aperture is no longer covered with water in the first portion proximate the first water level.
